(19) United States
(12) Patent Application Publication
(10) Pub. No.: US 2023/0069202 A1
(43) Pub. Date: Mar. 2, 2023

(54) PRODUCTION OF LOW OR NO CARBON INTENSITY HYDROGEN

(71) Applicant: Reset Energy, LP, Midland, TX (US)

(72) Inventors: Garath Fulks, Katy, TX (US); Benjamin Ciotti, Fulshear, TX (US)

(21) Appl. No.: 17/901,556

(22) Filed: Sep. 1, 2022

Related U.S. Application Data
(60) Provisional application No. 63/239,659, filed on Sep. 1, 2021.

(51) Int. Cl. C01B 3/48; C01B 3/56; C01B 3/50; C01B 3/52; C01B 32/50

(52) U.S. Cl. CPC C01B 3/48; C01B 3/56; C01B 3/501; C01B 3/52; C01B 32/50; C01B 2203/0233; C01B 2203/0283; C01B 2203/0475; C01B 2203/042; C01B 2203/0405; C01B 2203/0415; C01B 2203/0844; C01B 2203/0883; C01B 2203/1241; C01B 2203/1294; C01B 2203/127

(57) ABSTRACT

A process for producing low or no carbon intensity hydrogen. In one embodiment, the process includes the step of pretreating a hydrocarbon gas stream. The pretreated hydrocarbon gas stream is fed into a reformer. The pretreated hydrocarbon gas steam is heated in the reformer to produce a synthesis gas stream and a flue gas stream. The flue gas stream is fed to a waste heat recovery section. Waste heat is recovered to increase the thermal efficiency of the process. The synthesis gas stream is fed to a shift gas reactor. Carbon monoxide from the synthesis gas stream in the shift gas reactor is converted to produce hydrogen and carbon dioxide. The carbon dioxide is separated from the synthesis gas stream and the hydrogen is separated. In another embodiment, the carbon dioxide is captured following the hydrogen separation. In another embodiment, the carbon dioxide is captured from the flue gas.

### CROSS-REFERENCE TO RELATED APPLICATIONS

This application claims benefit under 35 U.S.C. 119(e) of U.S. Provisional Application Ser. No. 63/239,659 filed Sep. 1, 2021, which is hereby expressly incorporated herein by reference in its entirety.

### FIELD OF THE DISCLOSURE

The present disclosure relates to a process for the production of low or no carbon intensity hydrogen fuels and chemical feedstocks. The primary applications of the process relate to transportation fuels, power generation, chemical feedstock processing, carbon capture, sequestration, use, and storage and ammonia production.

### BACKGROUND

Steam methane reforming or steam hydrocarbon reforming is the most common method of hydrogen production today. When utilizing steam hydrocarbon reforming, carbon dioxide is produced at several points in the process. As such, selection of the approach to carbon capture is dependent on process and economic specifics.

To this end, a need exists for a process for producing low or no carbon intensity hydrogen fuels and chemical feedstocks. It is to such a process that the present disclosure is directed.

### BRIEF DESCRIPTION OF THE DRAWING(S)

FIG. 1 depicts possible arrangements for carbon capture integration within a hydrogen generation system.

FIG. 2 is a basic flow diagram of one embodiment of a process in accordance with the present disclosure.

### DETAILED DESCRIPTION

Before explaining at least one embodiment of the inventive concept disclosed herein in detail, it is to be understood that the inventive concept is not limited in its application to the details of construction, experiments, exemplary data, and/or the arrangement of the components set forth in the following description, or illustrated in the drawings. The presently disclosed and claimed inventive concept is capable of other embodiments or of being practiced or carried out in various ways. Also, it is to be understood that the phraseology and terminology employed herein is for purpose of description only and should not be regarded as limiting in any way.

In the following detailed description of embodiments of the inventive concept, numerous specific details are set forth in order to provide a more thorough understanding of the inventive concept. However, it will be apparent to one of ordinary skill in the art that the inventive concept within the disclosure may be practiced without these specific details. In other instances, well-known features have not been described in detail to avoid unnecessarily complicating the instant disclosure.

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the inventive concept. This description should be read to include one or at least one and the singular also includes the plural unless it is obvious that it is meant otherwise.

Finally, as used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

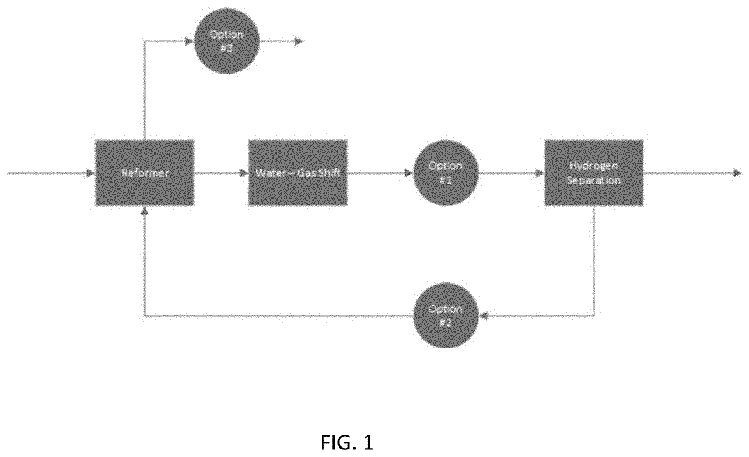

Referring now to the drawings, and more particularly to FIG. 1 depicting possible arrangements (Options 1-3) for carbon capture integration within the hydrogen generation system of the present invention.

Option 1 considers capturing carbon dioxide from the synthesis gas stream exiting the Water-Gas Shift reactor. This stream typically consists of the following components: water, hydrogen, carbon monoxide, carbon dioxide, nitrogen, residual hydrocarbon, and a small amount of ammonia. Typical recovery is 40%-70% of the carbon dioxide produced by the process.

Option 2 considers capturing carbon dioxide following hydrogen separation. Separation technologies can include pressure swing adsorption, membrane separation, and pressure swing adsorption. This stream is typically referred to as “Off gas”, “Waste gas”, or “Purge gas”. Typical recovery is 40%-70% of the carbon dioxide produced by the process.

Off gas is mixed with a hydrocarbon stream and combusted to provide heat for the reforming reaction. Option 3 considers capturing carbon dioxide from the post-combustion flue gas. A blower or compressor can be used to boost stream pressure. Typical recovery is 70%-100% of the carbon dioxide produced by the process.

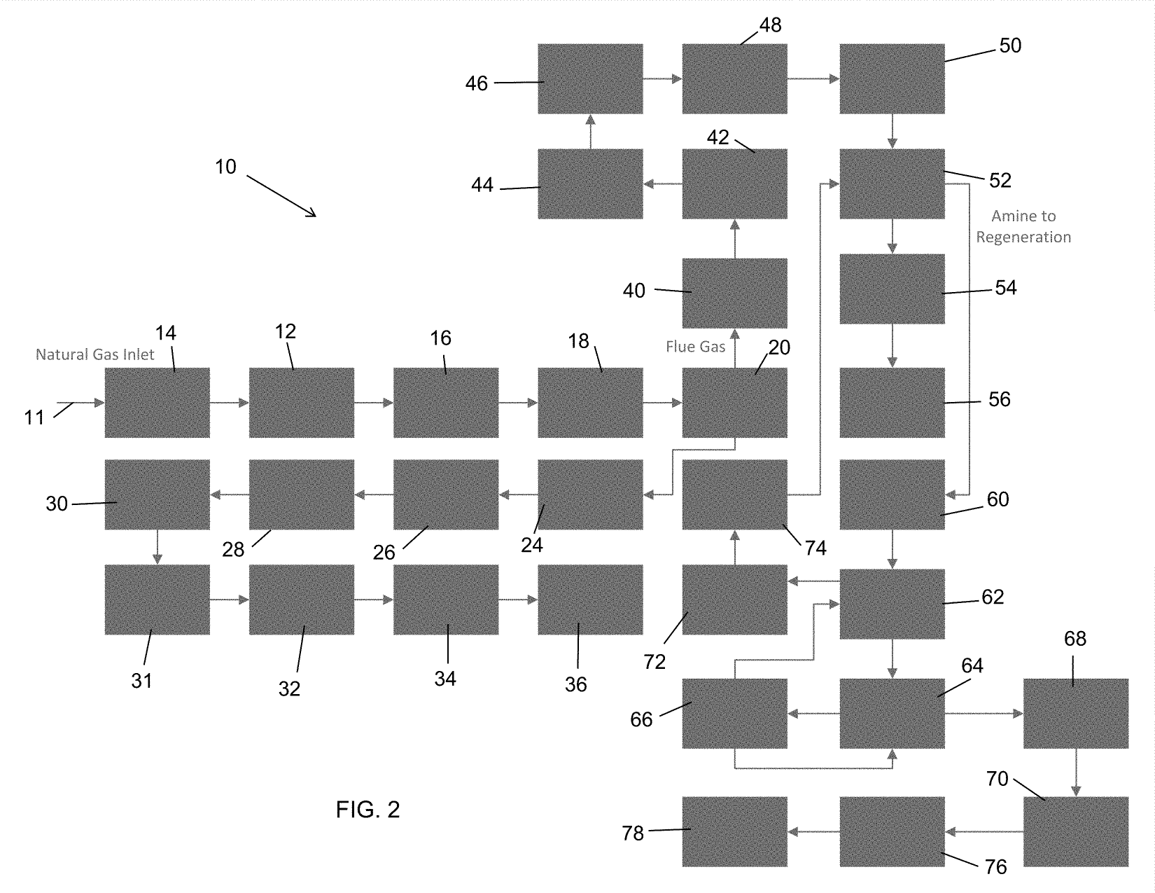

Referring now to FIG. 2, shown therein is one embodiment of a process for producing low or no carbon intensity hydrogen 10 constructed in accordance with the inventive concepts disclosed herein. It will be understood by one of ordinary skill in the art that various arrangements and conditions may be utilized based on the present invention.

A gaseous hydrocarbon stream 11 is sent to an inlet coalescer 12. Entrained water, liquid hydrocarbon, lubricating oil, and other contaminants are removed. In some cases, it may be necessary to boost the pressure of the inlet hydrocarbon stream using a blower or a compressor 14. In certain conditions, the inlet hydrocarbon stream is mixed with a slipstream of hydrogen product from a back end of the plant. The mixed stream is sent to the waste heat recovery section 16 of the reformer and heated. The heated stream is sent to a desulfurizer vessel 18 to remove sulfur species, primarily hydrogen sulfide and mercaptans.

A reformer 20 consists of a fired heater with single or multiple burners. In many cases, vertical or horizontal tubes are placed throughout the heater in a way that facilitates primarily radiant and convective heat transfer. The vertical tubes are filled with catalyst. A portion of the heated inlet gas is diverted to provide supplemental energy to the reformer burner(s). The majority of the heated inlet gas is comingled with steam and sent to the mixed feed preheat exchanger in the reformer waste heat recovery section. The mixed feed is fed through the catalyst-filled reformer tubes, facilitating the primary reformation of hydrocarbons and water into synthesis gas. The primary reaction taking place inside the reformer tubes is described below:

CH₄+H₂O [symbol] CO+3H₂

Synthesis gas exits the reformer tubes and is cooled in the process gas boiler 24. The process gas boiler 24 may be replaced with a direct contact cooling method under certain circumstances. Steam generated in the process gas boiler 24 is sent to an elevated steam drum (not shown). The synthesis gas stream exits the process gas boiler 24 and is sent to the water-gas shift reactor 26. The water-gas shift reactor 26 is preferably a catalyst filled vertical vessel. The water-gas shift reactor 26 facilitates the conversion of carbon monoxide to hydrogen and carbon dioxide. The primary reaction taking place inside the water-gas shift reactor 26 is described below:

CO+H₂O [symbol] CO₂+H₂

The synthesis gas stream is cooled in a boiler feed water cross exchanger 28, and further cooled in the shift cooler 30. The boiler feed water cross exchanger 28 may be eliminated under certain conditions. The two-phase synthesis gas stream is sent to a water separator 31. Bottoms from the water separator 31 are sent to water treatment, to be reused within the facility. Overhead synthesis gas from the separator 31 is sent to a water coalescer 32. The coalescer 32 removes water droplets entrained in the vapor. The coalescer 32 also serves to protect the downstream separation equipment from liquids.

The synthesis gas stream is sent to pressure swing adsorption 34 and hydrogen is separated out in a product stream. Membrane separation may be used in place of pressure swing adsorption 34 under certain circumstances. Off gas from the pressure swing adsorption system 34 or membrane separation system is sent to the reformer burner(s) for fuel. Hydrogen is sent downstream to compression, use, or storage 36.

Reformer flue gas is sent to a waste heat recovery section 40 comprised of several heat transfer coils. This section 40 is used to recover heat from the combustion reaction in the reformer and increase the overall process thermal efficiency. Waste heat not recovered for the hydrogen production process is used to generate steam to provide heat to the amine regeneration system. The order of heat recovery exchanger coils, with decreasing flue gas temperature, is as follows: boiler feed water preheater, mixed feed preheater, natural gas feed preheater, steam coil 1, steam coil 2.

Flue gas exits the waste heat recovery section 40 and is cooled in a flue gas cooler 42. The cooled flue gas stream is sent to a flue gas inlet separator 44 to remove water. Bottoms from the separator are sent to water treatment to be reused within the facility. Overhead flue gas from the separator 44 is compressed using a blower or compressor 46. Compressed flue gas is cooled and sent to a flue gas outlet separator 50. Bottoms from the separator 50 are sent to water treatment to be reused within the facility.

Overhead flue gas from the separator 50 is sent to the amine absorber 52. In certain conditions, it is appropriate to include an inlet water wash arrangement for the flue gas stream. The amine absorber 52 removes carbon dioxide from the flue gas stream using a regenerated amine solvent. The amine absorber 52 contains sections of trays, packing, or some combination thereof to facilitate mass transfer and carbon dioxide removal. Overhead flue gas from the amine absorber 52 is sent to the overhead cooler 54 and cooled. The flue gas is then sent to a separator 56 to remove any condensed liquid. Bottoms liquid is sent to the amine regeneration system, and overhead flue gas is sent to the atmosphere.

The bottoms from the amine absorber 52 (rich amine) are pumped through filtration 60—the solids filter, activated carbon filter, and another guard solids filter. The rich amine stream is sent to a lean/rich cross exchanger 62, used to recover heat from the amine reboiler bottoms stream (lean amine). The rich amine is sent to the top of a regenerator 64. The regenerator 64 is a reboiled stripper that contains sections of trays, packing, or some combination thereof.

Steam generated in a reboiler 66 removes carbon dioxide from the amine solution. The overhead stream from the regenerator 64 is cooled, condensing most of the water vapor in a reflux condenser 68. The mixed phase stream is sent to a reflux accumulator 70. Liquid bottoms from the separator are pumped to the top of the regenerator as reflux. Lean amine from the reboiler 66 is cooled in the lean/rich cross exchanger 62. The lean amine stream is pumped to an amine cooler 72 and sent to the top of a amine absorber 74. In certain conditions, it is appropriate to include solids filtration and activated carbon filtration downstream of the amine cooler 72.

Vapor overhead from the reflux accumulator 70 is sent to a compressor 76. The stream is compressed to prepare for carbon dioxide sequestration, storage, or use 78. Liquid water formed during the series of compression and cooling is sent to water treatment for use elsewhere.

The steam system is integrated into the process described above. Water from a well or municipal source is sent to the reverse osmosis unit and used as makeup. In certain conditions, it is appropriate to include multiple stages of reverse osmosis. Makeup water is comingled with steam condensate and process condensate and sent to the deaerator. The overhead vapor from the deaerator is sent to atmosphere. The deaerator contains allowances for oxygen scavenger and corrosion inhibitor injection. The bottoms water from the deaerator is pumped and split into portions sent to the boiler feed water cross exchanger, boiler feed water preheat coil, and steam coil. The outlet of each of these is sent to the steam drum. Liquid bottoms from the steam drum are split, and a portion is sent to the process gas boiler while the remaining stream is sent to a steam coil. The outlet of each of these is sent to the steam drum. The overhead vapor from the steam drum is sent to the amine reboiler, as well as other auxiliary steam users. Steam condensate is collected and recycled in the system.

A hydrogen generation system employing carbon capture, storage, use, and sequestration is disclosed herein. Hydrogen and carbon dioxide are produced in a steam methane reformer or steam hydrocarbon reformer. Carbon dioxide associated with hydrogen production or processing is captured using regenerative amine solvent system.

The captured carbon dioxide is compressed and sent to temporary storage (manmade or geologic), permanent storage (manmade or geologic), sales applications (chemical processing, food and beverage, industrial, construction, medical), enhanced oil recovery applications, or other typical applications.

From the above description, it is clear that the inventive concept(s) disclosed herein is well-adapted to carry out the objects and to attain the advantages mentioned herein as well as those inherent in the inventive concept disclosed herein. While exemplary embodiments of the inventive concept disclosed herein have been described for purposes of this disclosure, it will be understood that numerous changes may be made which will readily suggest themselves to those skilled in the art and which are accomplished without departing from the scope of the inventive concept disclosed herein and defined by the appended claims.

What is claimed is:

1. A process for producing low or no carbon intensity hydrogen, comprising the steps of:
pretreating a hydrocarbon gas stream;
feeding the pretreated hydrocarbon gas stream into a reformer;
heating the pretreated hydrocarbon gas steam in the reformer to produce a synthesis gas stream and a flue gas stream;
feeding the flue gas stream to a waste heat recovery section;
recovering waste heat so as to increase the thermal efficiency of the process;
feeding the synthesis gas stream to a shift gas reactor;
converting carbon monoxide from the synthesis gas stream in the shift gas reactor to produce hydrogen and carbon dioxide;
separating the carbon dioxide from the synthesis gas stream; and
separating the hydrogen.

2. The process of claim 1 wherein the waste heat recovery section includes a plurality of heat transfer coils, comprising:
a boiler feed water preheater;
a mixed feed preheater;
a natural gas feed preheater; and
at least one steam coil.

3. The process of claim 1 further comprising the step of:
feeding a heated stream to a desulfurizer vessel to remove sulfur.

4. The process of claim 1, further comprising the step of:
separating hydrogen from the synthesis gas stream by pressure swing adsorption.

5. The process of claim 1, further comprising the step of:
separating hydrogen from the synthesis gas stream by membrane separation.

6. A process for producing low or no carbon intensity hydrogen, comprising the steps of:
pretreating a hydrocarbon gas stream;
feeding the pretreated hydrocarbon gas stream into a reformer;
heating the pretreated hydrocarbon gas steam in the reformer to produce a synthesis gas stream and a flue gas stream;
feeding the flue gas stream to a waste heat recovery section;
recovering waste heat so as to increase the thermal efficiency of the process;
feeding the synthesis gas stream to a shift gas reactor;
converting carbon monoxide from the synthesis gas stream in the shift gas reactor to produce hydrogen and carbon dioxide;
separating the hydrogen; and
separating the carbon dioxide from the synthesis gas stream.

7. The process of claim 6 wherein the waste heat recovery section includes a plurality of heat transfer coils, comprising:
a boiler feed water preheater;
a mixed feed preheater;
a natural gas feed preheater; and
at least one steam coil.

8. The process of claim 6 further comprising the step of:
feeding a heated stream to a desulfurizer vessel to remove sulfur.

9. The process of claim 6, further comprising the step of:
separating hydrogen from the synthesis gas stream by pressure swing adsorption.

10. The process of claim 6, further comprising the step of:
separating hydrogen from the synthesis gas stream by membrane separation.

11. A process for producing low or no carbon intensity hydrogen, comprising the steps of:
pretreating a hydrocarbon gas stream;
feeding the pretreated hydrocarbon gas stream into a reformer;
heating the pretreated hydrocarbon gas steam in the reformer to produce a synthesis gas stream and a flue gas stream;
feeding the flue gas stream to a waste heat recovery section;
recovering waste heat so as to increase the thermal efficiency of the process; and
separating carbon dioxide from the flue gas stream.

12. The process of claim 11 wherein the waste heat recovery section includes a plurality of heat transfer coils, comprising:
a boiler feed water preheater;
a mixed feed preheater;
a natural gas feed preheater; and
at least one steam coil.

13. The process of claim 11, further comprising the step of:
feeding the flue gas to an amine absorber to remove the carbon dioxide from the flue gas stream.

14. The process of claim 13 wherein a regenerated amine solvent is used.

15. The process of claim 11, further comprising the step of:
providing a blower to increase the flue gas stream pressure.
